(19) United States
(12) Patent Application Publication
(10) Pub. No.: US 2012/0153746 A1
(43) Pub. Date: Jun. 21, 2012

(54) NETWORK CONNECTOR MODULE WITH SWITCHING FUNCTION

(76) Inventor: Nai-Chien CHANG, New Taipei City (TW)

(21) Appl. No.: 13/330,491

(22) Filed: Dec. 19, 2011

(30) Foreign Application Priority Data
Dec. 20, 2010 (CN) 201020670942.8

(51) Int. Cl. H02B 1/00

(52) U.S. Cl. 307/112

(57) ABSTRACT

A network connector module with switching function for connecting with a first connecting terminal, a second connecting terminal and a switch unit installed within a electronic device electrically connected between a first connecting terminal and a second connecting terminal, a detector circuit electrically connected to the switch unit, a network connecting port and a processing unit electrically connected between a detector circuit and a network connecting port. The first connecting terminal connects to an external power. The second connecting terminal connects to an electronic component of the electronic device which requires power supply. The network connector module connects to the internet via network connecting ports. Thus, the external terminal connects to the electronic device via the internet for remotely control ON/OFF of the switch unit. When the switch unit is ON, the component within the electronic device receives the power provided by the external power.

### BACKGROUND OF THE INVENTION

1. Field of the Invention

The present invention relates to a network connector, in particular, the present invention relates a network connector module with an internal switch.

2. Description of Prior Art

With the development of technologies, there are various electronic devices utilized to make everyday life much more convenient than the past.

All electronic devices have to be powered via a power cable to receive power required for operating tasks. Nonetheless, the researches indicate that when the power cable of an electronic device is plugged in a power socket, there is leakage current leaked at power socket and as a result more power is wasted when more electronic devices are plugged in when not in use.

In terms of the concern, there are suggestions raised to save power. The suggestions such as unplugging the power cable from the power socket after electronic device is switched OFF to save power. Nonetheless, unplugging power cable may lead to hardware damage and accordingly users have to spend extra money for replacing the damaged hardware.

Therefore, there is a power connector with switch provided in the market. FIG. 1 is a solid diagram of a power connector of the prior art. The power connector 1 with a switch for directly controlling ON/OFF of the socket 11 via power button 12 next to socket 11. As a result, the user does not need to unplug the power cable outside of the electronic device from the socket 11, instead, the user controls the power supply via the power button 12.

Though, the switching of the power button 12 and unplugging the power cable are both manual operation step. It is possible that a user often forgets to switch off the power button 12 of the power connector 1 and the function of the power button 12 is not performed. In addition, the power button 12 is often a mechanical switch which only allows a user to switch manually outside of the power connector 1. Also a plurality of the power connectors 1 outside of the power buttons 12 cannot be managed as a group and the power button 12 cannot be switched remotely.

In view of the above disadvantages, there are new designs desired in the market to make it convenient to users to control electronic devices remotely when the users forget to unplug the power cables, and switch off the power button of the power connector. Or the users are allowed to remotely control the ON/OFF switching of the power on electronic devices when in need.

### SUMMARY OF THE INVENTION

The objective of the present invention is to provide a network connector module with switching function for remotely control the ON/OFF of power supply to an electronic device installed with the network connector module via the internet.

In order to accomplish the above objective, the installed electronic device of the present invention has a first connecting terminal, a second connecting terminal, a switch unit electrically connected between a first connecting terminal and a second connecting terminal, a detector circuit electrically connected to switch unit, a network connecting port and processing unit electrically connected between the detector circuit and the network connecting port. The first connecting terminal connects to an external power, and the second connecting terminal connects to an electronic component within electronic device which requires power. The network connector module connects to the internet via the network connecting port. Thus, the external terminal connects to the electronic device via the internet for remotely controlling ON/OFF of the switch unit.

Compare to the prior art, the advantages achieved by the present invention include that the electronic device connects to the internet via the network connector module. Thus, the external terminal connects to the electronic device for checking power status of the electronic device, and sends control commands via an external terminal for controlling ON/OFF of the switch unit within the network connector module. Accordingly, users are allowed to remotely control the power supply of the electronic device and conserves electrical power.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a solid diagram of the prior art;

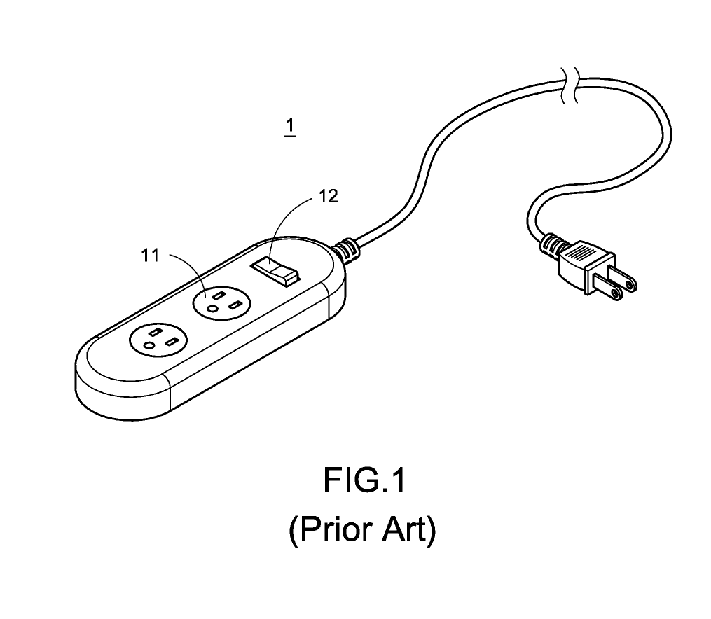

FIG. 2 is a solid diagram of the network connector module according to a preferred embodiment of the present invention;

FIG. 3 is a block diagram of the network connector module according to a preferred embodiment of the present invention;

FIG. 4 is a connection schematic diagram of the network connector module according to a preferred embodiment of the present invention;

FIG. 5 is a block diagram of the network connector module according to another preferred embodiment of the present invention;

FIG. 6 is a solid diagram of the network connector module according to a preferred embodiment of the present invention; and

FIG. 7 is a block diagram of the network connector module according to a preferred embodiment of the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

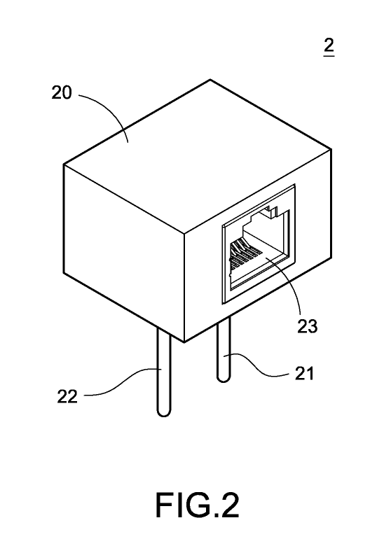

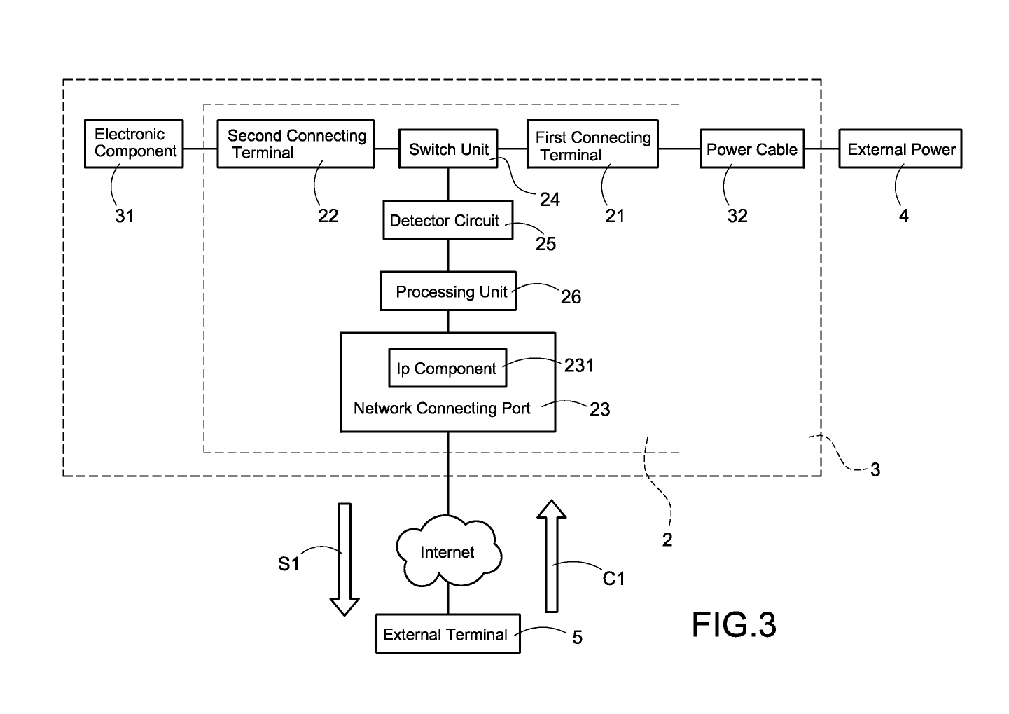

FIG. 2 and FIG. 3 are a solid diagram and a block diagram of the network connector module according to a preferred embodiment of the present invention. The network connector module with switching function 2 of the present invention (referred as the network connector module 2 in the following description) installed within a electronic device 3 has: a first connecting terminal 21, a power cable 32 electrically connected to the electronic device 3 for connecting to a external power 4, a second connecting terminal 22 for connecting to electronic component 31 (such as a microcontroller, a motor and a lamp etc.) of the electronic device 3 which requires power, a switch unit 24 electrically connected between the first connecting terminal 21 and the second connecting terminal 22; a processing unit 26 electrically connected to the switch unit 24 which receives, processes a control command C1 and controls ON/OFF of the switch unit 24 according to the content of the control command C1, a detector circuit 25 electrically connected to the switch unit 24 and the processing unit 26 for detecting the status of the switch unit 24 to generate a detected signals S1 to transmit to the processing unit 26 for processing, and a network connecting port 23 electrically connected to the processing unit 26.

As described above, the network connecting port 23 is used for receiving the external network cable (not shown), where the electronic device 3 connects to the internet via the network connector module 2 to transmit the outgoing detected signals S1 and receives the incoming control command C1. As mentioned above, an external terminal 5 connects to the electronic device 3 via the internet. The network connector module 2 generates the detected signals S1 via the detector circuit 25 to transmit to the processing unit 26. The detected signal S1 is transmitted outbound to the external terminal 5 via the network connecting port 23. The detected signals S1 is received by the external terminal 5 and used as a reference to generate the external control command C1 to transmit to the electronic device 3. The electronic device 3 receives the control command C1 via the network connector module 2. The network connector module 2 transmits the control command C1 to the processing unit 26 to process. The processing unit 26 controls ON/OFF of the switch unit 24 according to the content of the control command C1. The detector circuit 25 is used for detecting the ON/OFF status of the switch unit 24. The ON/OFF status of the switch unit 24 is used for indicating the power status of the electronic device 3.

The network connector module 2 further comprises a casing 20 for housing the network connecting port 23, the switch unit 24, the detector circuit 25 and the processing unit 26. The interface ports of the first connecting terminal 21, the second connecting terminal 22 and the network connecting port 23 are exposed outside of the casing 20, where the first connecting terminal 21 connects to the power cable 32, the second connecting terminal 22 connects to the electronic component 31, and the network cable is plugged in the network connecting port 23.

The network connecting port 23 has an Internet Protocol (IP) component 231. The IP component 231 is integrated with various internet communication protocols. When a network cable is plugged in the network connecting port 23, the electronic device 3 connects to the internet via the IP component 231 within the network connector module 2 for establishing connection with the external terminal 5. Thus the network connector module 2 is allowed to remotely control the external terminal 5.

As shown in FIG. 3, the network connector module 2 is connected in series between the power cable 32 within the electronic device 3 and the electronic component 31 which requires power. The network connector module 2 connects to the internet via the network connecting port 23 so as to perform network control function. The network connecting port 23 is a RJ-45 connecting port, and the switch unit 24 is a electronic relay but is not limited thereto. When the processing unit 26 receives the control command C1, and the switch unit 24 is controlled by the processing unit 26 and turns ON, the electronic component 31 connects to the power cable 32 via the second connecting terminal 22, the switch unit 24 and the first connecting terminal 21 to receive power provided by the external power 4. When the switch unit 24 is controlled by the processing unit 26 and turns OFF, the connection between the electronic component 31 and the external power 4 is cut and the electronic component 31 cannot receive power.

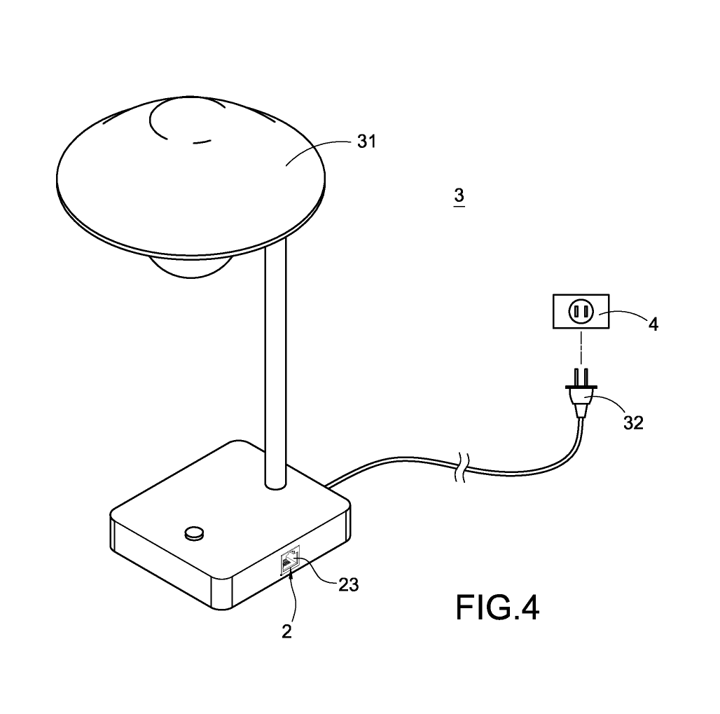

FIG. 4 is a connection schematic diagram of the network connector module according to a preferred embodiment of the present invention. The electronic device 3 shown in FIG. 4 is a lamp fixture installed with the network connector module 2, the electronic device 3 connects to the internet via the network connector module 2 to enable the network control function. A user remotely receives the detected signals S1 and sends the control command C1 via the external terminal 5 so as to control ON/OFF of the switch unit 24 within the network connector module 2. Further, the user control ON/OFF of the switch unit 24 and control the power status (i.e. ON/OFF) of the electronic component 31 (i.e. the lamp tube in the diagram) within the electronic device 3 (i.e. the lamp fixture in the diagram).

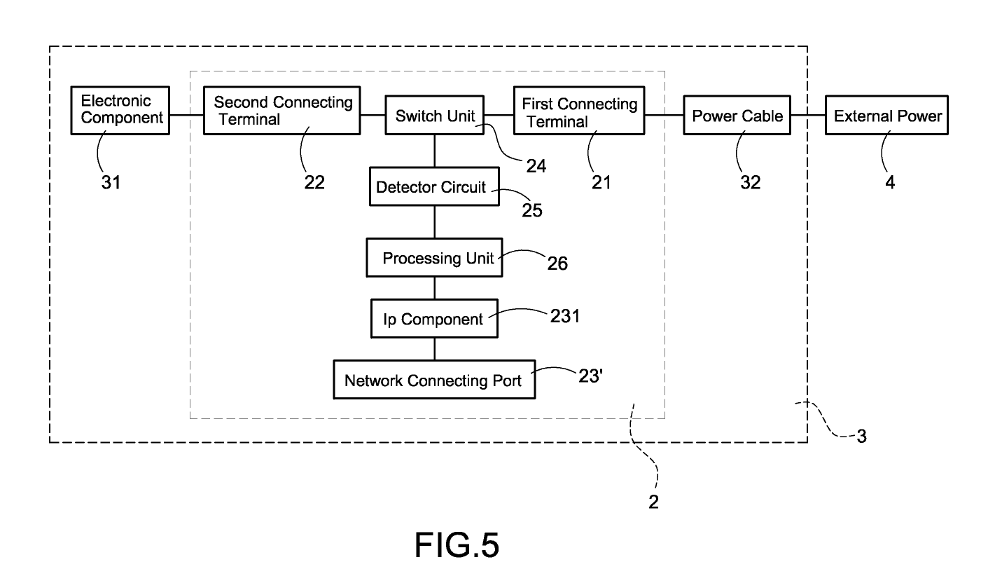

FIG. 5 is a block diagram of the network connector module according to another preferred embodiment of the present invention. In FIG. 3, the IP component 231 is installed in the network connecting port 23, the IP component 231 can be an independent module electrically connected to the processing unit 26 and the network connecting port 23′. The electronic device 3 connects to the internet via the IP component 231 and the network connecting port 23 within the network connector module 2 and establishes the connection with the external terminal 5. Thus electronic device 3 is allowed to remotely control the external terminal 5. In the present embodiment, the network connector module 2 uses a conventional network connecting port 23′. It is not required to produce a network connecting port 23 installed with the IP component 231 to make it more convenient in the manufacturing process.

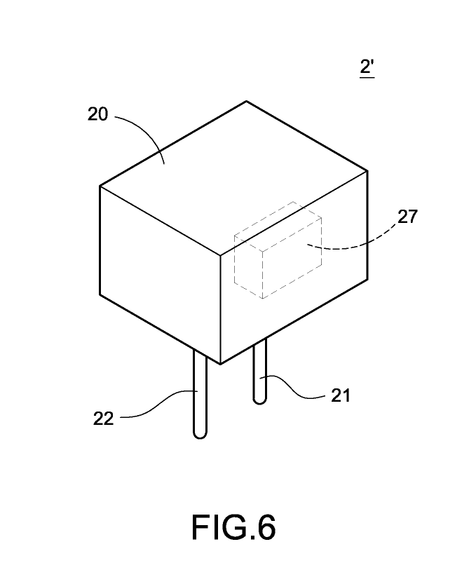

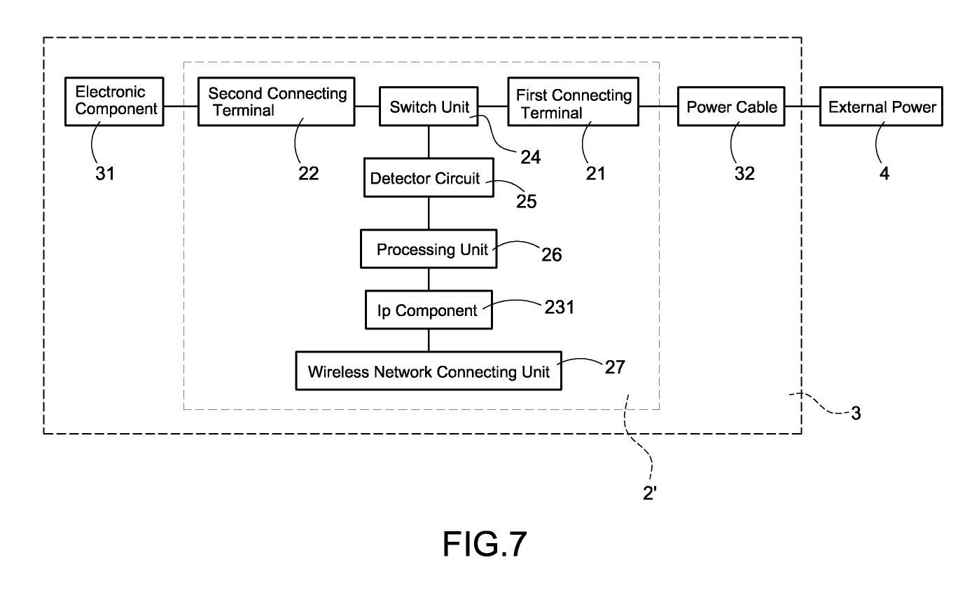

FIG. 6 is a solid diagram of the network connector module according to a preferred embodiment of the present invention, and FIG. 7 is a block diagram of the network connector module according to a preferred embodiment of the present invention. In addition to the above mentioned network connector module 2, the present invention further provides a wireless network connector module 2′. The network connector module 2′ utilizes a wireless network connecting unit 27 to replace the network connecting port 23. The combination of the wireless network connecting unit 27 and the IP component 231 is used for wirelessly connecting to the internet and connecting with the external terminal 5 for remotely controls the external terminal 5.

The wireless network connecting unit 27 on the network connector module 2′ does not have the network cable plugged in and has the network connector module 2′ with the electronic device 3. The wireless network connecting unit 27 wirelessly connects to the internet, sends the detected signals S1 to the external terminal 5 and receives the control command C1 from the external terminal 5 for controlling ON/OFF of the switch unit 24 within the network connector module 2′. Further, the control command C1 is used for controlling power status of the electronic component 31 which requires power within the electronic device 3. Accordingly, the electronic device 3 provides the network control functions without a network cable plugged in which is useful and convenient to users

As the skilled person will appreciate, various changes and modifications can be made to the described embodiments. It is intended to include all such variations, modifications and equivalents which fall within the scope of the invention, as defined in the accompanying claims.

What is claimed is:

1. A network connector module with switching function installed within an electronic device, wherein the network connector module is connected in series between a power cable within the electronic device and an electronic component requiring power supply, the power cable is connected to an external power, the network connector module with switching function comprising:
a first connecting terminal connected to the power cable of the electronic device;
a second connecting terminal connected to the electronic component within the electronic device;
a switch unit electrically connected between the first connecting terminal and the second connecting terminal;
a processing unit electrically connected to the switch unit for receiving and processing a control command transmitted from a external terminal to control on or off status of the switch unit according to the content of the control command;
a detector circuit electrically connected to the switch unit and the processing unit for detecting the status of the switch unit, the detector circuit generating a detected signal and transmitting the detected signal to the processing unit for processing; and
a network connecting port electrically connected to the processing unit;
wherein, the network connector module connects to the internet via the network connecting port, the detected signal is transmitted to the external terminal, and the external terminal receives the control command.

2. The network connector module with switching function of claim 1, wherein the network connecting port is an RJ-45 connecting port, and the network connecting port is used for receiving external network cable for connecting to the internet.

3. The network connector module with switching function of claim 2, wherein the network connector module further comprises a casing for housing the switch unit, the detector circuit, the processing unit and the network connecting port, wherein, the first connecting terminal, the second connecting terminal and the network connecting port are exposed outside of the casing.

4. The network connector module with switching function of claim 1, wherein the network connecting port is a wireless network connecting unit, and the network connector module is wireless connected to the internet via the wireless network connecting unit.

5. The network connector module with switching function of claim 1, wherein the switch unit is an electronic relay.

6. The network connector module with switching function of claim 5, wherein the network connecting port has an internet protocol (IP) component, the network connector module is connected to the external terminal via the IP component and remotely controlled by the external terminal.

7. The network connector module with switching function of claim 5, wherein the network connector module has an IP component, electrically connected to the processing unit and the network connecting port, the network connector module is connected to the external terminal via the IP component and remotely controlled by the external terminal.
